(19) United States
(12) Patent Application Publication
(10) Pub. No.: US 2014/0007817 A1
(43) Pub. Date: Jan. 9, 2014

(54) FINGER MITT FOR USE IN CLEANING AN ANIMAL'S EARS

(71) Applicants: Alan T. Fanelli, East Lyme, CT (US); Carol Kamm, East Lyme, CT (US)

(72) Inventors: Alan T. Fanelli, East Lyme, CT (US); Carol Kamm, East Lyme, CT (US)

(21) Appl. No.: 13/931,889

(22) Filed: Jun. 29, 2013

Related U.S. Application Data
(60) Provisional application No. 61/690,839, filed on Jul. 6, 2012.

(51) Int. Cl. A01K 13/00

(52) U.S. Cl. CPC A01K 13/001
USPC 119/603; 119/600

(57) ABSTRACT

A finger mitt for cleaning an animal's ear, the finger mitt including an elongated finger portion having a closed end and an open end, the finger portion being formed of a soft cloth and configured for receiving a user's finger extending through the open end towards the closed end. The finger mitt further including a cuff attached to the open end of the finger portion, the cuff for engaging the user's finger for securing the finger mitt to the user's finger. The finger mitt configured for removing wax and/or other debris from an animal's ear.

### CROSS REFERENCE TO RELATED APPLICATIONS

This application claims priority to U.S. Provisional Patent Application Ser. No. 61/690,839 filed Jul. 6, 2012, entitled Single Finger Miniature Mitt For Cleaning Pet's Ears, the contents of which are incorporated herein by reference in its entirety.

### FIELD OF THE INVENTION

The present invention relates generally to animal health care and more particularly to a finger mitt for cleaning an animal's ears.

### BACKGROUND OF THE INVENTION

A dog's regular grooming and maintenance should include regular ear checks and cleanings. This is especially important for dogs who may produce excessive ear wax or may have a lot of inner-ear hair. Most domestic pet owners and professionals will agree that one of the most difficult tasks in grooming their animal is cleaning their pet's ears. One problem associated with cleaning an animal's ears is that no specialized tools are currently available to safely and effectively clean an animal's ears.

It is well known that Q-tips or pointed objects should never be used to clean an animal's ears as these types of tools could cause damage to the ear canal. One veterinary recommended method is to wipe the inner ear with a cotton ball. Other known methods include using a tissue such as Kleenex® tissue. However, these types of materials may leave a lint or fabric residue in the area of the ear and are somewhat cumbersome to use within the ear of an animal as they require at least two fingers to grasp the cotton ball or tissue.

Accordingly, what is needed is a new implement which can be used for cleaning and/or massaging an animal's ear which addresses the above-identified deficiencies of the prior art and provides improvements thereto.

### BRIEF DESCRIPTION OF THE INVENTION

As described herein, the exemplary embodiments of the present invention overcome one or more disadvantages known in the art.

The present invention provides a finger mitt for cleaning an animal's ear including an elongated finger portion having a closed end and an open end, the finger portion being formed of a soft cloth and configured for receiving a user's finger extending through the open end towards the closed end, and a cuff attached to the open end, the cuff for engaging the user's finger for securing the finger mitt to the user's finger. The finger mitt being configured for removing wax and/or other debris from an animal's ear.

One advantage of the present invention finger mitt is that only one finger of a user can be used to effectively and safely wipe, clean and/or massage an animal's ear using a soft pliable cloth implement according to the present invention. Further the finger mitt can be used to wipe and clean the inside of an animal's ear while the user's thumb holds and massages the back side of the ear.

In one embodiment the finger portion is made from a terry cloth. In one embodiment, cuff portion is ribbed and/or elastic for securing the finger mitt to a finger of the user.

In one embodiment, a finger mitt of the present invention includes a finger portion made from an absorbent material for holding an ear wash solution.

In one embodiment, a finger mitt according to the present invention includes the closed end of the finger portion having a rounded end for conforming to the end of a user's finger.

In one embodiment, the finger mitt according to the present invention includes the finger portion being made from a blend of materials including viscose from bamboo, cotton and polyester.

These and other aspects and advantages of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and, unless otherwise indicated, they are merely intended to conceptually illustrate the structures and procedures described herein.

### BRIEF DESCRIPTION OF THE FIGURES

In the drawings, like elements are numbered alike in the several figures described briefly following:

FIG. 1 is a perspective view of a finger mitt according to one embodiment of the present invention;

FIG. 2 is a front side view of a another embodiment of a finger mitt of the present invention;

FIG. 3 is a rear side view of the finger mitt of FIG. 2;

FIG. 4 is a perspective view of the finger mitt of FIG. 2 shown as used on the index finger of a user;

FIG. 5 is an elevational view of an embodiment of a finger mitt of the present invention shown turned inside out;

FIG. 6 is an end view of the finger mitt of FIG. 2;

FIG. 7 is an illustration of one embodiment of a finger mitt according to the present invention as used for cleaning a dog's ear; and

FIG. 8 is another illustration of an embodiment of a finger mitt according to the present invention as used for cleaning a dog's ear.

### DETAILED DESCRIPTION OF EMBODIMENTS OF THE INVENTION

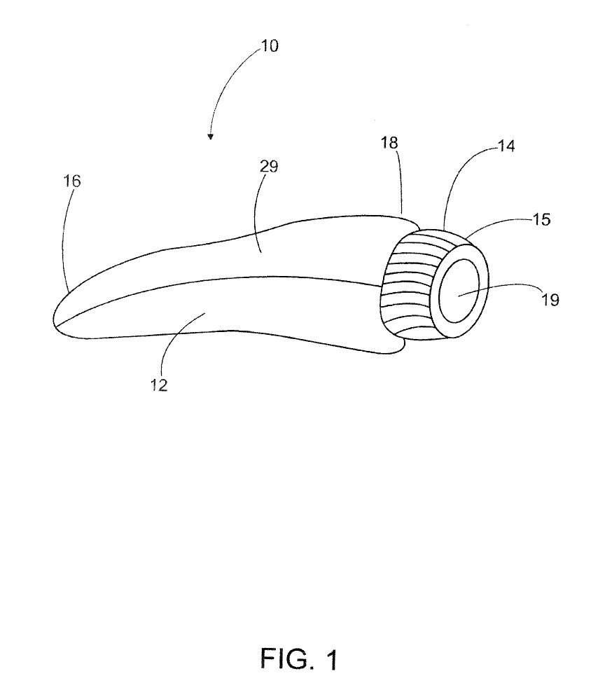

Referring to FIGS. 1, 2, and 5, a finger mitt 10, 100, 200 according to the present invention is shown and includes a finger portion 12 and a cuff 14. The finger portion 12 is elongated having a closed end 16 and an open end 18. The cuff 14 defines an opening 19 aligned with the open end 18 of the finger portion 12. In one embodiment, the cuff 14 is formed of an elastic material for engaging the finger 120 of a user wearing the finger mitt 10, 100, 200.

In one embodiment, the finger mitt 10, 100, 200 includes a finger portion 12 that is formed of a soft cloth such as a terry cloth or double-sided terry cloth. The terry cloth or double sided terry cloth can be of an absorbent material such as a cotton, a cotton polyester blended fabric or other soft fabrics. In one embodiment, the finger portion 12 is formed of a blended fabric comprising viscose of bamboo, cotton and polyester knit. In one embodiment, the finger portion is formed from a terry cloth or double sided terry cloth comprising about 62% viscose from bamboo, about 27% cotton and about 11% polyester knit by weight. The finger portion 12 is preferably made of a soft and pliable cloth for engaging and/or massaging the soft cartilage tissue of an animal's ear.

The finger portion 12 is preferably absorbent for holding a liquid such as ear wash solution to be applied to an ear of an animal such as a dog or cat. The finger portion 12 can hold a volume of a liquid ear wash solution for applying the solution to the pinna, ear flap and/or outer ear of an animal such as a dog or cat. Once applied to the outer ear cartilage, the ear wash can enter the ear canal. In one embodiment, the finger portion 12 of finger mitt 10, 100, 200 holds a volume of ear wash solution or other fluid in a range between about 2.0 ml to about 3.5 ml. In another embodiment, the absorbent finger portion 12 holds in a range of about 2.5 ml to about 3.0 ml of fluid. The finger portion 12 can also be used to hold and/or apply other fluids or materials such as a salve, medication or other solution or composition to an animal's ear and/or other body parts.

Additionally, the absorbent material of the finger portion 12 can be used for drying or removing liquid or other materials from the ear of a dog or other animal. The absorbent finger portion 12 of the finger mitt 10, 100, 200 can be used in an animal's ear dry for absorbing and/or collecting excess ear wash solution, ear wax, debris, infection secretions, or other fluids, materials or substances which may be present in an animal's ear. The finger portion 12 is preferably formed of an absorbent material for collecting any such fluid, debris or materials. As set forth above, in one embodiment the finger portion 12 is made of an absorbent material configured to absorb and retain fluids in a range of about 2.0 ml to about 3.5 ml. In other embodiments designed for specialized applications such as for surgical or veterinary use, the finger portion 12 can be formed of a material having a higher absorbency for holding greater than 3.5 ml of fluid such as gauze or other highly absorbent materials.

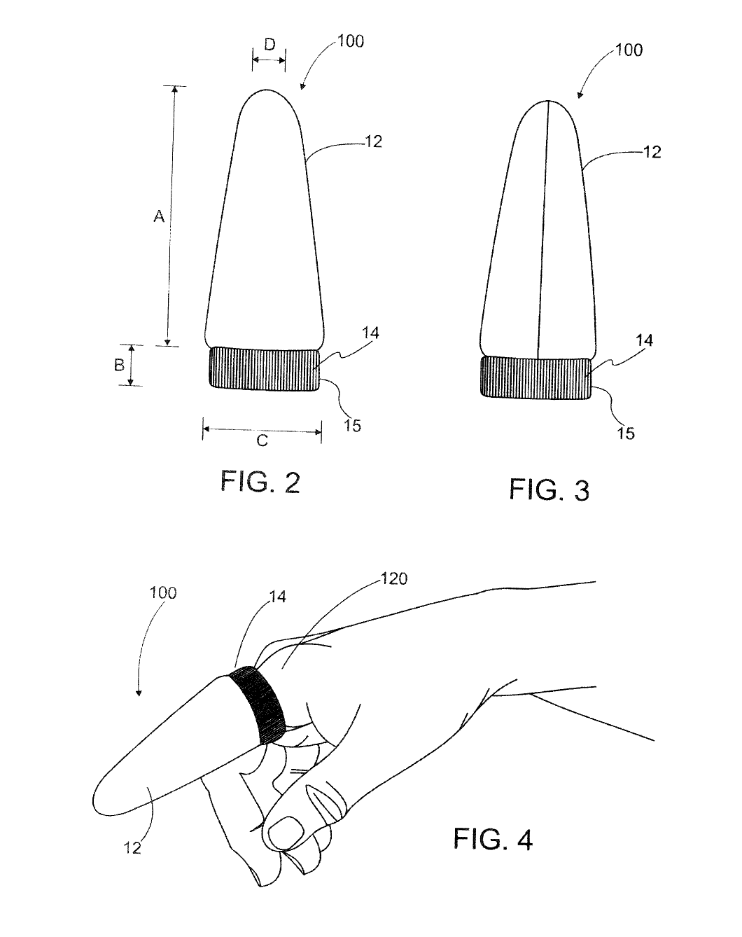

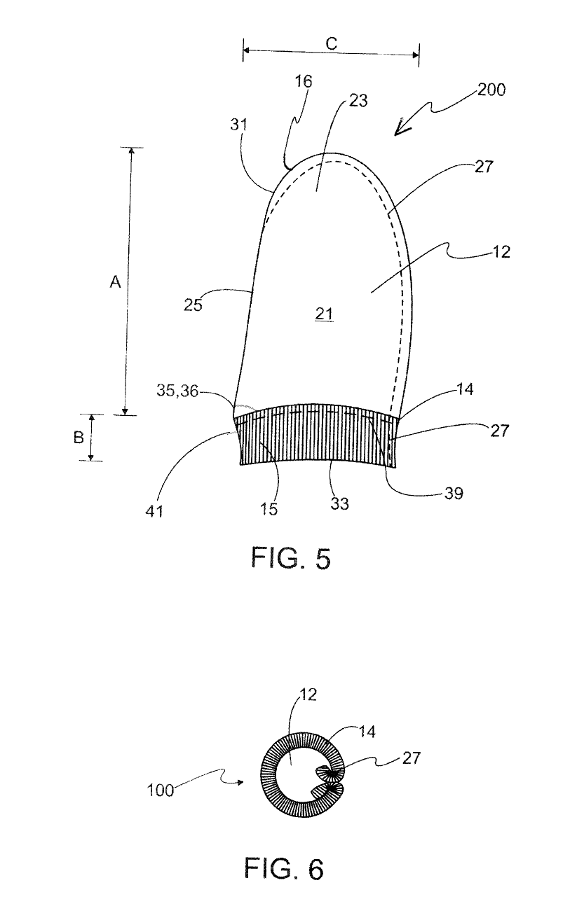

The finger portion 12 of the finger mitt 10, 100, 200 is configured to fit over a finger of a user for cleaning the ears or other body parts of an animal such as a dog or cat. Referring to FIGS. 2 and 5, in one embodiment the finger portion 12 defines a length A measured from the cuff 14 to the closed end 16 of the finger mitt 10, 100, 200. In one embodiment the length A is in a range from about 2 inches to about 3.5 inches. In another embodiment, the length A is in a range from about 2.25 inches to about 3 inches. In another embodiment of the finger mitt 10, 100, 200, the length A of the finger portion 12 is in a range of about 2.25 inches to about 2.75 inches. In another embodiment, the length A of the finger portion 12 is about 2.5 inches.

As shown in FIG. 2, the finger mitt 100 defines a finger portion 12 that is tapered along the length A narrowing from the cuff 14 towards the closed end 16. The tapered length A is designed to conform to a finger of a user of the finger mitt 100. In one embodiment, the width of the finger portion 12 tapers from a width C of about 1.5 inches at the cuff to a width D of about 0.75 inches at the closed end 16. In other embodiments, the width of the finger portion 12 tapers from a width C about 1.5 inches at the cuff 14 to a width D of about 1.0 inches at the closed end 16. (The width measurements set forth herein with respect to the finger portion 12 and cuff portion 14 are taken with the finger mitt 10, 100, 200 laid flat on a generally flat surface.)

As shown in the FIG. 5 embodiment, the width of the finger portion is uniform substantially the entire length A thereof. In one embodiment, the width C of the finger portion 12 is in a range from about 1.25 inches to about 2.0 inches throughout substantially the length A of the finger portion. In another embodiment, the width C of the finger portion is substantially uniform throughout the length A thereof and measures in a range of about 1.25 inches to about 1.75 inches on the outside surface thereof when the material is laid flat. In another embodiment, the width C of the finger portion 12 is about 1.5 inches throughout substantially the length A thereof. In yet another embodiment, the width C of the finger portion 12 is about 1.375 inches throughout substantially the length A of the finger portion.

Still referring to FIGS. 1, 2 and 5, the cuff 14 of the finger mitt 10, 100, 200 is formed of an elastic material 15 for engaging a finger 120 of a user and to secure the finger mitt 10, 100, 200 to the user's finger (e.g., the index finger). In one embodiment, the cuff 14 is configured to engage the user's finger securely so that fluid (such as an ear wash solution) applied to the finger portion 12 through the cuff 14 is retained in the finger portion and prevented from leaking past the cuff 14 and out of the finger mitt 10, 100, 200.

In one embodiment, the cuff 14 is formed of a ribbed nylon material. Alternatively, in other embodiments of the finger mitt 10, 100, 200, the cuff 14 can be formed of other materials including materials having elastic properties.

As shown in FIGS. 2 and 5, embodiments of the cuff 14 define a length B, measured in the direction of the length A of the finger portion 12, in a range from about 0.25 inches to about 0.75 inches. In another embodiment, the cuff 14 has a length B of about 0.375 inches. In another embodiment, the cuff 14 has a length B of about 0.4375 inches.

Referring again to FIG. 5, an embodiment of a finger mitt 200 is shown turned inside out wherein an inside surface 21 of the finger portion 12 is depicted. As shown, the finger portion 12 is formed of a single piece of fabric 23 having a fold 25 along the length A thereof. Stitching 27 extends around the closed end 16 of the finger portion and along the length of the finger portion 12 opposite the fold 25 forming a finger cavity 29 (See FIG. 1) as described herein above. The finger cavity 29 being configured for receiving a finger of a user of the finger mitt 10, 100, 200. As shown in FIG. 15, the finger portion 12 defines a rounded end 31 at the closed end 16 thereof for conforming to the end of a user's finger. In other embodiments (not shown) the closed end 16 is straight.

Still referring to FIGS. 1 and 5, in one embodiment the cuff 14 defines a fold 33 at the opening 19 thereof. The open ends 35, 36 of the cuff 14 opposite the fold 33 are stitched together and to the finger portion 12 via stitching 39 disposed around the entire open end 18 of the finger portion. As shown in FIGS. 5 and 6, the stitching 27 extends through the length B of the cuff 14 securing the ends of the cuff material 15 together and forming the opening 19 thereof.

As shown in the FIGS. 2 and 5 embodiments the cuff material 15 defines ribs 41 disposed along the length B of the cuff 14 forming an elastic band around the opening 19 of the cuff. The elasticity of the ribs 41 facilitate securing the finger mitt 10, 100, 200 to a finger 120 of a user.

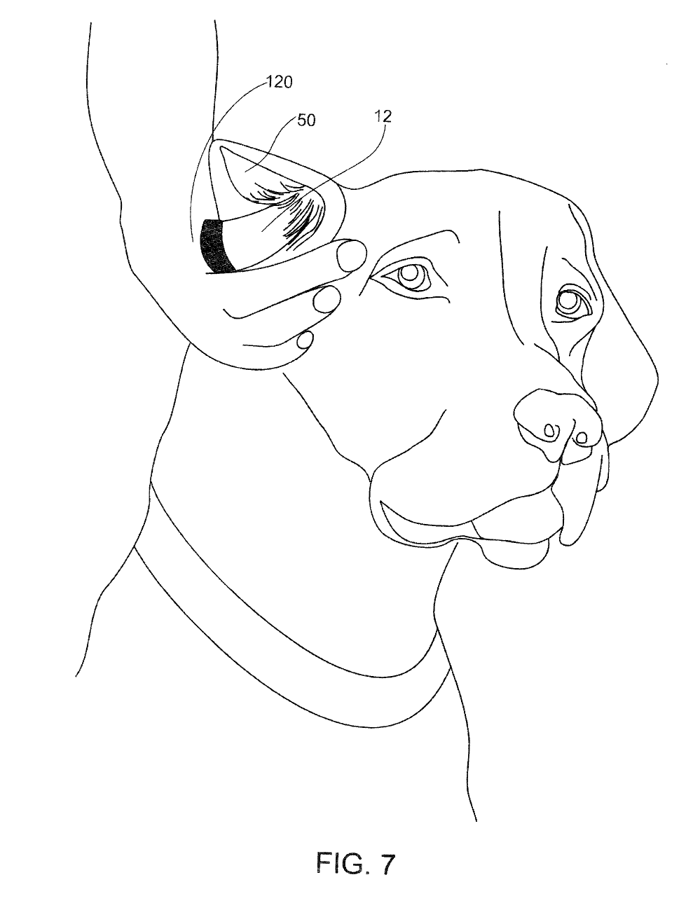

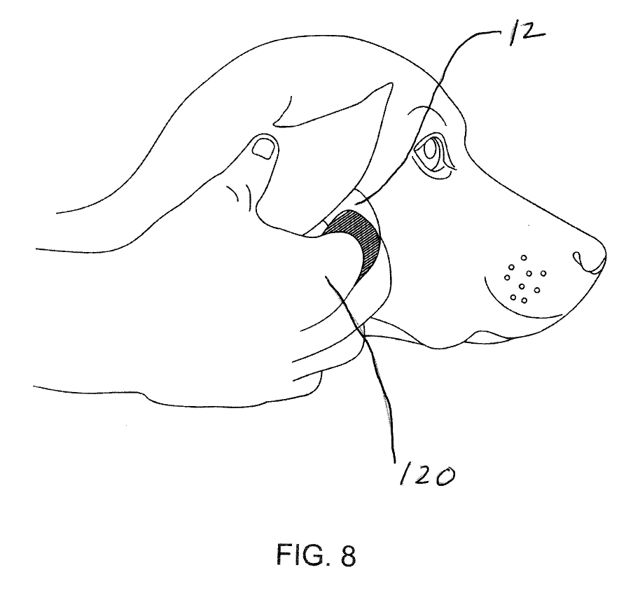

Referring to FIGS. 4, 7 and 8, to use the finger mitt 10, 100, 200, for cleaning a dog's ear, a user places the finger mitt over his/her finger (e.g., index finger 120) and extends the finger into the finger mitt so that the end of the finger 120 abuts an inside surface of the closed end 16.

One method of cleaning an animal's ears (e.g., a dog) includes soaking the entire finger portion 12 with an ear wash solution until the finger portion 12 is saturated and the ear wash solution drips from the finger portion. For larger animals, or when a lot of the ear wash solution is desired to be used, a tip of a bottle of the ear wash solution (not shown) can be inserted under the cuff 14 of the finger mitt 10, 100, 200 and between the finger cuff and the user's finger 120. With the tip pointing into the finger portion 12, squeeze the bottle of ear wash solution injecting a volume of the ear wash solution into the finger cavity 29 of the finger portion 12. The tip can be moved around the cuff 14 to saturate the finger portion 12 with the ear wash until the finger portion 12 is saturated or a desired amount of the ear wash is applied to the finger portion.

The user can then begin to clean and wash the entire inner ear flap 50 of an animal's ear while massaging the rear side of the ear with the user's thumb. The excess ear wash fluid from the finger mitt 10, 100, 200 will naturally flow into the ear canal and loosen any accumulated wax and debris. It is recommended to continue washing and massaging the inner surface of the ear flap for at least 25 to 30 seconds.

Thereafter, the finger mitt can be rotated approximately 180 degrees relative to the user's finger so that a clean section of the finger mitt is adjacent the pad of the user's finger. A liberal amount of ear wash is then re-applied to the finger portion 12 of the finger mitt 10, 100, 200 for cleaning the other ear. The process set forth above is repeated for cleaning the animal's other ear. If necessary, both sides of the finger mitt 10, 100, 200 can be used on a single ear and a second clean finger mitt can be used for the other ear.

For animals that really dislike having their ears cleaned, the finger mitt 10, 100, 200 can be used dry at first to massage the animal's ear including occasionally inserting the mitted finger into the inner ear flap. As the animal becomes accustomed to the inner ear massage, a small amount of an ear wash solution can then be introduced to the finger portion 12 of the finger mitt 10, 100, 200. At each subsequent cleaning process, a larger quantity of ear wash can be applied to the finger mitt 10, 100, 200. In due course the animal will become accustomed to the ear wash and actually enjoy the ear massage and the owner will be able to effectively and safely keep the animal's ears clean.

The finger mitt 10, 100, 200 can be washed either by hand or in a regular washing machine. However, the Applicants recommend placing the finger mitt 10, 100, 200 inside a mesh bag prior to washing the finger mitt in a washing machine due to the relatively small size of an individual finger mitt.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A finger mitt for cleaning an animal's ear comprising:
an elongated finger portion having a closed end and an open end, the finger portion being formed of a soft cloth and configured for receiving a user's finger extending through the open end towards the closed end;
a cuff attached to the open end, the cuff for engaging the user's finger for securing the finger mitt thereto;
the finger mitt configured for removing wax and/or other debris from an animal's ear.

2. The finger mitt according to claim 1 wherein the finger portion is made from a terry cloth.

3. The finger mitt according to claim 1 wherein the cuff portion is ribbed.

4. The finger mitt according to claim 1 wherein the cuff portion is elastic.

5. The finger mitt according to claim 1 wherein the finger portion is made of a single piece of material sewn along a side thereof and around the closed end, the finger portion defining a finger cavity for receiving a user's finger.

6. The finger mitt according to claim 1 wherein the finger portion is made from an absorbent material for holding an ear wash solution.

7. The finger mitt according to claim 6 wherein the finger portion is configured to hold an ear wash solution in a range from about 2 ml to about 3.5 ml.

8. The finger mitt according to claim 6 wherein the finger portion is configured to hold an ear wash solution in a range from about 2.5 ml to about 3.0 ml.

9. The finger mitt according to claim 1 wherein the finger portion has a length in a range of about 2.25 inches to about 3.0 inches.

10. The finger mitt according to claim 1 wherein the cuff is formed integral with the finger portion.

11. The finger mitt according to claim 1 wherein the closed end of the finger portion defines a rounded end for conforming to the end of a user's finger.

12. The finger mitt according to claim 1 wherein the finger portion is made of a double terry cloth.

13. The finger mitt according to claim 1 wherein the finger portion is made from a blend of materials selected from a group consisting of viscose from bamboo, cotton and polyester.

14. The finger mitt according to claim 1 wherein the finger portion is made from a terry cloth comprising about 62% viscose from bamboo, about 27% percent cotton and about 11% polyester knit by weight.

15. The finger mitt according to claim 1 wherein the finger mitt is washable.

16. A finger mitt for cleaning an animal's ear comprising:
an elongated finger portion having a closed end and an open end, the finger portion being formed of a soft terry cloth and configured for receiving a user's finger extending through the open end towards the closed end, the terry cloth being absorbent for holding ear wash in a range of about 2.0 ml to about 3.0 ml;
a cuff attached to the second end, the cuff for engaging the user's finger for securing the finger mitt thereto, the cuff formed of an elastic nylon; and wherein
the finger mitt for use in applying ear wash into an animal's ear and removing wax and/or other debris from inside an animal's ear.

17. The finger mitt according to claim 16 wherein the finger portion is made from a terry cloth material comprising about 62% viscose from bamboo, about 27% cotton and about 11% polyester knit.

18. The finger mitt according to claim 16 wherein the cuff portion is made from nylon.

19. The finger mitt according to claim 16 wherein the finger portion is configured to fit an adult's index finger.

20. The finger mitt according to claim 16 wherein the finger portion defines a finger cavity for receiving the finger of a user.
